(19) United States
(12) Patent Application Publication
(10) Pub. No.: US 2012/0047201 A1
(43) Pub. Date: Feb. 23, 2012

(54) APPARATUS AND METHOD OF ACQUIRING OR DISTRIBUTING CONTENT

(76) Inventor: Nikhil JAIN, San Diego, CA (US)

(21) Appl. No.: 13/079,701

(22) Filed: Apr. 4, 2011

Related U.S. Application Data
(60) Provisional application No. 61/375,240, filed on Aug. 20, 2010.

(51) Int. Cl. G06F 15/16

(52) U.S. Cl. 709/203; 709/218; 709/216

(57) ABSTRACT

Apparatus and methods distribute content by identifying a type of at least one available wireless communication link, selecting at least one content item for distribution based on a distribution rule that prioritizes the distribution according to a prioritization code of the content item and according to the type of the at least one available wireless communication link. Additionally, apparatus and methods selectively acquire, on a wireless device, one or more of the prioritized content. Thus, the described aspects enable efficient pushing of content to wireless devices over selected wireless communication links.

### CLAIM OF PRIORITY UNDER 35 U.S.C. §119

The present application for patent claims priority to Provisional Application No. 61/375,240 entitled “Apparatus and Method of Acquiring or Distributing Content” filed Aug. 20, 2010, and assigned to the assignee hereof and hereby expressly incorporated by reference herein.

### BACKGROUND

The present disclosure relates generally to wireless communications, and more specifically to an apparatus and method of acquiring or distributing content via a wireless communication network.

Today's wireless Internet is a pull system, where the use model assumes that the device is always connected and the user then downloads whatever is needed. The problem with this model is that wireless communication, by virtue of its physics, is unpredictable. For example, there are places where a user may get good connectivity and other places where the user may get poor connectivity. Therefore, in the current wireless Internet pull system, it is hard to ensure that the user can get a consistent experience all over the geography where the user wants to access the Internet.

In addition, in the future, it is expected that wireless network carriers may place a premium price on accessing their WAN network services.

Thus, improvements in distributing or obtaining content via wireless communication links are desired.

### SUMMARY

The following presents a simplified summary in order to provide a basic understanding of some aspects of the disclosed aspects. This summary is not an extensive overview and is intended to neither identify key or critical elements nor delineate the scope of such aspects. Its purpose is to present some concepts of the described features in a simplified form as a prelude to the more detailed description that is presented later.

In one aspect, a method for distributing content comprises identifying a type of at least one available wireless communication link. The method further includes selecting at least one content for distribution based on a distribution rule that prioritizes the distribution of the content according to a prioritization code corresponding to the content and according to the type of the at least one available wireless communication link. The method further includes distributing the at least one content via the at least one available wireless communication link.

Other aspects include one or more of: at least one processor configured to perform the above-noted method; a computer program product comprising a non-transitory computer readable medium having instructions executable by a computer to perform the above-noted method; a computer device having one or means for performing the actions of the above-noted method; or a computer device having a processor in communication with a memory, wherein the processor is configured to execute one or more instructions stored in the memory for performing the above-noted method.

In another aspect, a method of acquiring content on a mobile device comprises identifying a presence of content to download via at least one wireless interface. The content to download is available via the at least one wireless interface based on a distribution rule that prioritizes a distribution of the content according to a prioritization code and according to a type of a wireless communication link corresponding to the at least one wireless interface. The method further includes determining to download the content via the at least one wireless interface and downloading the content via the at least one wireless interface.

Other aspects include one or more of: at least one processor configured to perform the above-noted method; a computer program product comprising a non-transitory computer readable medium having instructions executable by a computer to perform the above-noted method; a computer device having one or means for performing the actions of the above-noted method; or a computer device having a processor in communication with a memory, wherein the processor is configured to execute one or more instructions stored in the memory for performing the above-noted method.

In one aspect, the present disclosure provides a method for acquiring content by receiving a first portion of a content item via a one-to-many transmission at a device from a first link, detecting a triggering event for the content item, and accessing a second portion of the content item via a second transmission.

In another aspect, the present disclosure provides at least one processor for acquiring content. A first module receives a first portion of a content item via a one-to-many transmission at a device from a first link. A second module detects a triggering event for the content item. A third module accesses a second portion of the content item via a second transmission.

In an additional aspect, the present disclosure provides a computer program product for acquiring content comprising a non-transitory computer-readable storage medium for storing instructions. At least one instruction causes a computer to receive a first portion of a content item via a one-to-many transmission at a device from a first link. At least one instruction causes the computer to detect a triggering event for the content item. At least one instruction causes the computer to access a second portion of the content item via a second transmission.

In a further aspect, the present disclosure provides an apparatus for acquiring content. The apparatus comprises means for receiving a first portion of a content item via a one-to-many transmission at a device from a first link. The apparatus comprises means for detecting a triggering event for the content item. The apparatus comprises means for accessing a second portion of the content item via a second transmission.

In yet another aspect, the present disclosure provides an apparatus for acquiring content. A receiver receives a first portion of a content item via a one-to-many transmission at a device from a first link. A computing platform detects a triggering event for the content item. The receiver further accesses a second portion of the content item via a second transmission.

In yet an additional aspect, the present disclosure provides a method for distributing content by chain reaction encoding a content item, transmitting the content item as encoded via a one-to-many transmission from a first link to a population of mobile devices, and retransmitting at least a portion of the content item as encoded via a second transmission.

In yet a further aspect, the present disclosure provides at least one processor for distributing content. A first module chain reaction encodes a content item. A second module transmits the content item as encoded via a one-to-many transmission from a first link to a population of mobile devices. A third module retransmits at least a portion of the content item as encoded via a second transmission.

In another aspect, the present disclosure provides a computer program product for distributing content comprising a non-transitory computer-readable storage medium for storing instructions. At least one instruction causes a computer to chain reaction encode a content item. At least one instruction causes the computer to transmit the content item as encoded via a one-to-many transmission from a first link to a population of mobile devices. At least one instruction causes the computer to retransmit at least a portion of the content item as encoded via a second transmission.

In an additional aspect, the present disclosure provides an apparatus for distributing content. The apparatus comprises means for chain reaction encoding a content item. The apparatus comprises means for transmitting the content item as encoded via a one-to-many transmission from a first link to a population of mobile devices. The apparatus comprises means for retransmitting at least a portion of the content item as encoded via a second transmission.

In a further aspect, the present disclosure provides an apparatus for distributing content. An encoder chain reaction encodes a content item. A transmitter transmits the content item as encoded via a one-to-many transmission from a first link to a population of mobile devices. A network interface retransmits at least a portion of the content item as encoded via a second transmission.

In one aspect, the present disclosure provides a method for acquiring content in a mobile environment by receiving a content item by an autonomous network interface at a device, caching the content item by the autonomous network interface in a computer-readable storage medium, and accessing of the content item by a content consuming component at a device. In one exemplary aspect, the method further is for suspending operation of a computing platform that executes the content consuming component while receiving the content item by the autonomous network interface. In another exemplary aspect, the method is further for receiving the content item by the autonomous network interface at the device via a one-to-many transmission.

In another aspect, the present disclosure provides at least one processor for acquiring content in a mobile environment. A first module receives a content item by an autonomous network interface at a device. A second module caches the content item by the autonomous network interface in a computer-readable storage medium. A third module accesses the content item by a content consuming component at the device.

In an additional aspect, the present disclosure provides a computer program product for acquiring content in a mobile environment. A non-transitory computer-readable storage medium stores instructions. At least one instruction causes a computer to receive a content item by an autonomous network interface at a device. At least one instruction causes the computer to cache the content item by the autonomous network interface in a computer-readable storage medium. At least one instruction causes the computer to access the content item by a content consuming component at the device.

In a further aspect, the present disclosure provides an apparatus for acquiring content in a mobile environment. The apparatus comprises means for receiving a content item by an autonomous network interface at a device. The apparatus comprises means for caching the content item by the autonomous network interface in a computer-readable storage medium. The apparatus comprises means for accessing the content item by a content consuming component at the device.

In yet another aspect, the present disclosure provides an apparatus for acquiring content in a mobile environment. An autonomous network interface receives a content item at a device and for caching the content item in a computer-readable storage medium. A content consuming component at the device accesses the content item.

To the accomplishment of the foregoing and related ends, one or more aspects comprise the features hereinafter fully described and particularly pointed out in the claims. The following description and the annexed drawings set forth in detail certain illustrative aspects and are indicative of but a few of the various ways in which the principles of the aspects may be employed. Other advantages and novel features will become apparent from the following detailed description when considered in conjunction with the drawings and the disclosed aspects are intended to include all such aspects and their equivalents.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout and wherein:

FIG. 1 is a schematic diagram of an aspect of a system of acquiring or distributing content, according to one aspect;

FIG. 2 is a block diagram of an aspect of a content delivery service apparatus for use in the system of FIG. 1, according to one aspect;

FIG. 3 is a block diagram of an aspect of a wireless device for use in the system of FIG. 1, according to one aspect;

FIG. 4 is a flow diagram of an aspect of a method of distributing content;

FIG. 5 is a flow diagram of an aspect of a method of acquiring content;

FIG. 6 is a block diagram of an aspect of an apparatus that distributes content;

FIG. 7 is a block diagram of an aspect of an apparatus that acquires content;

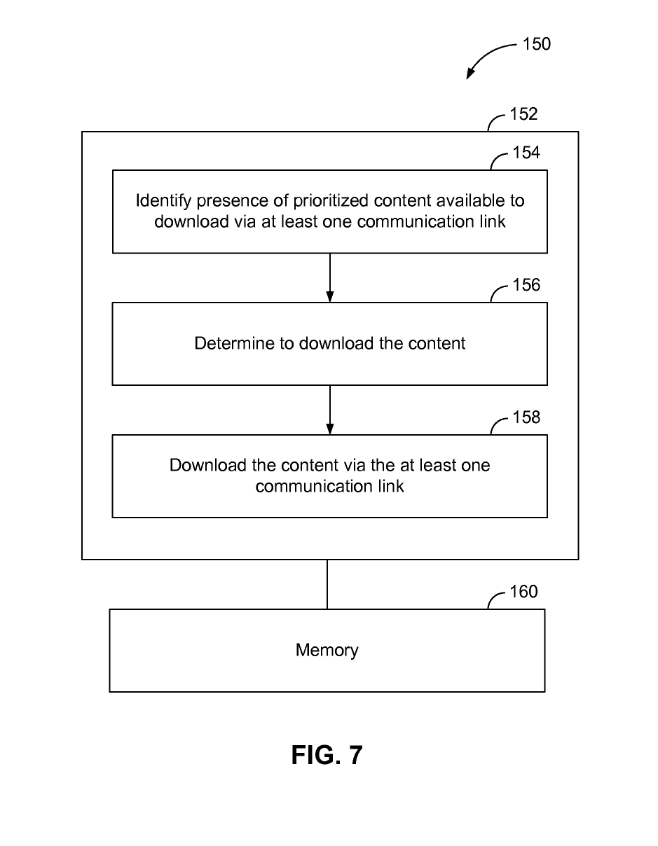

FIG. 8 is a schematic diagram of an aspect of a content distribution system;

FIG. 9 is a flow diagram of an aspect of a method of distributing content;

FIG. 10 is a flow diagram of an aspect of a method of acquiring content;

FIG. 11 is a block diagram of a system having logical groupings of electrical components for distributing content; and

FIG. 12 is a block diagram of a system having logical groupings of electrical components for acquiring content.

FIG. 13 is a schematic diagram of a communication system wherein an apparatus acquires content with an autonomous network interface, according to one aspect.

FIG. 14 is a flow diagram of a methodology for acquiring content with an autonomous network interface while suspending operation of a computing platform, according to one aspect.

FIG. 15 is a block diagram of a system having logical groupings of electrical components for acquiring content with an autonomous network interface while suspending operation of a computing platform, according to one aspect.

### DETAILED DESCRIPTION

The present aspects include apparatus and methods of providing content to, or acquiring content at, a wireless device. With respect to content delivery, the described apparatus and methods, such as a network-based content delivery service, identify types of available wireless communication links, such as based on a cost of using the respective link. Further, the described aspects then select one or more content items for distribution over the link or links based on a distribution rule. For example, the distribution rule may prioritize the content according to a prioritization code, such as value or fee received for distributing the content, and this priority may vary depending on the type of the communication link. With respect to content acquisition, a wireless communication device, such as a cellular phone or other similar device, may identify that the above-noted prioritized content is available for receipt, and then determine whether to download one or more of the prioritized content. For example, the wireless device may apply an acquisition rule to the available prioritized content to identify one or more content items that are suitable for downloading, such as based on matching an interest of the user of the wireless device. Thus, the described aspects and methods provide a push system for content distribution that efficiently utilizes selected wireless links and then efficiently prioritizes a sequence of content for distribution over those links, allowing a wireless device to further selectively download such content.

In an aspect, the described apparatus and methods include a smart download manager. For example, in an aspect, the smart download manager knows the cost associated with each of the networks that the device connects with, and downloads content in a least costly way. In one case, for example, content items may be downloaded when the wireless device is on a free WiFi network. In another aspect, updates to content items during the day may come by the way of a low cost broadcast network, or through low cost, short range networks, such as Femto cells. In other words, the described apparatus and methods prioritize the delivery of content over different connections and create a better and a cheaper connectivity solution for the user of the wireless device.

More specifically, the system has a smart server, e.g. the content delivery service, and a smart client, e.g. the download manager. In an aspect, the smart server prioritizes delivery of content items based on a pricing system. For example, content providers that pay more get to have their content item(s) go first in a prioritized sequence of one or more content items. Further, there may be a class of content item prioritization that allows a content item to be distributed in real-time, such as on a network like a 3G scavenger class network. Additionally, in an aspect, the smart client or download manager prioritizes acquisition of content items about which the user cares, such as based on a user profile. Accordingly, in an aspect, the download manager may include a download rule, also referred to as a content acquisition rule, that compares a content characteristic to a device user preference and identifies a match. So, for example, the smart client or download manager may first download content items that user likes to consume rather than content items that the content delivery service prioritizes. In other aspects, from the point of view of a content provider, the system may appear like a file syncing system, as files put on the server are delivered to the wireless device in a push manner. For instance, file syncing can be round robin with proportional fair scheduling wherein the weights are derived from an allocation file. In an exemplary aspect, the default priority of delivery is specified on the server. If the device consumes some content or if the user specifies a priority on the device then that priority can supersede that specified by the server.

Thus, in an aspect, the described apparatus and methods deliver all or some portion of content items, in a prioritized sequence, to one or more wireless devices via free or low cost communication links, thereby avoiding more costly WAN networks, such as 3G networks.

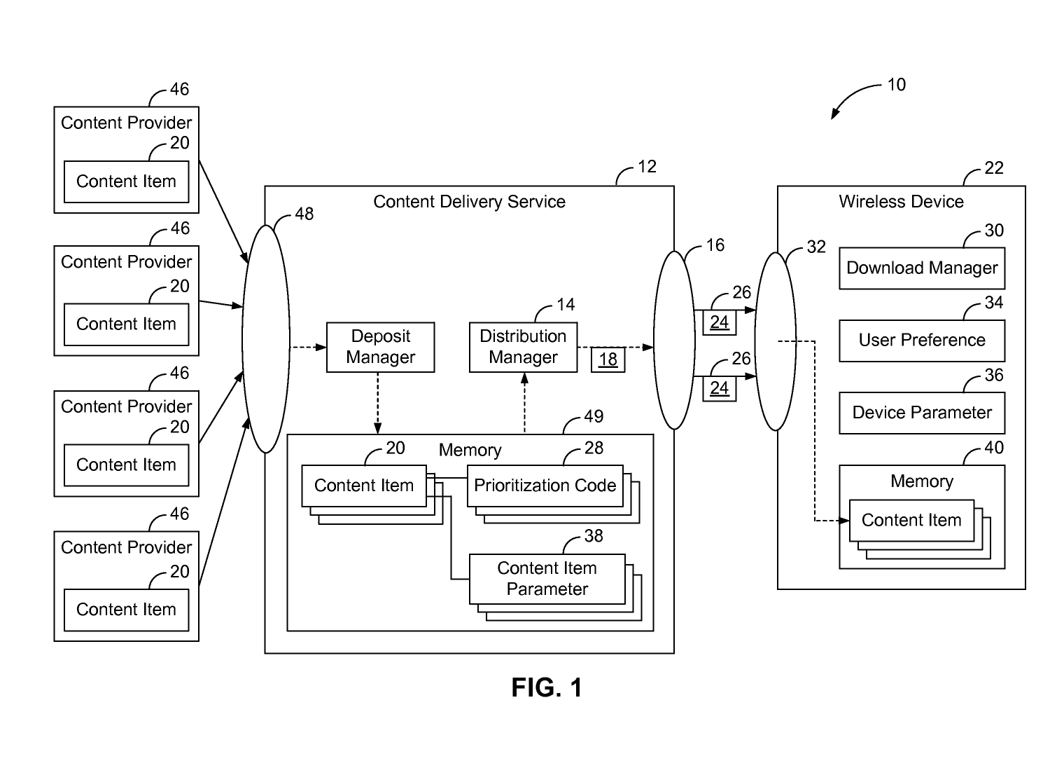

Referring to FIG. 1, in an aspect, a content delivery or acquisition system 10 includes a content delivery service 12, such as may be hosted by a network-based media server, having a distribution manager 14 that executes one or more distribution rules 16 to distribute a prioritized sequence 18 of one or more content items 20 to one or more wireless devices 22. Specifically, the one or more distribution rules 16 control content distribution according to a type 24 of one or more available communication links 26 between content delivery service 12 and a respective wireless device 22 and according to a prioritization code 28 corresponding to each content item 20. Thus, content delivery service 12 is able to push, in an ordered manner, one or more content items 20 to one or more wireless devices 22.

Content item 20 may include, but is not limited to, one or more types of information such as audio, video, text, a graphic, haptic information, a web page, a song, a movie, a book, and other similar electronic data that may be presented to or consumed by a user of wireless device 22. In addition, content item 20 can comprise media content and application content.

The term application as used herein refers to computer software program in general and can further encompass data, configuration settings, etc., used by the computer software program. Examples include utilities such as e-mail, Short Message Service (SMS) text utility, chat interface, web browsers, calculators, viewers, media players, games, etc. In an exemplary aspect, application can refer to software that is suitable for use on a mobile device, especially to being downloaded via a Wireless Local Access Network (WLAN) or Wireless Wide Area Network (WWAN).

Further, for example, the type 24 of the one or more available communication links 26 may relate to one or more communication link parameters, such as but not limited to a technology type (e.g. WiFi, WiMax, cellular, etc.), a cost of use of the link (e.g., free, cost per minute, cost per amount of data transmitted, etc.), a speed of the link, an available bandwidth of the link, or any other characteristic that defines the link or an operational attribute of the link. In an aspect, for example, the one or more distribution rules 16 may define a hierarchy or ordered list or ranking of a plurality of types 24 of communication links 26. In one case, for example, the one or more distribution rules 16 may rank distribution of content via a free communication link as being preferable to distribution over a fee-based communication link. Additionally, for example, prioritization code 28 may include, but is not limited to, a value or identifier that provides a measure of relative priority to enable content item priorities to be compared to rank or order each content item 20 to define prioritized sequence 18. In an aspect, each prioritization code 28 may correspond to a value associated with the corresponding content item 20, where the value may be based on, for example, a payment to be received or already received for distribution of the corresponding content item 20. In one instance, for example, the payment may be based on a winning bid of a content provider for a placement of the content item in a given relative position within prioritized sequence 18. Further, for example, in an aspect, one or more distribution rules 16 may define prioritized sequence 18 by comparing and ranking the respective prioritization code 28 of each of a plurality of content items 20 that are available for distribution. Further, for example, distribution manager 14 may generate a same, or a different, prioritized sequence 18 of content items 20 for distribution for each type 24 of the one or more communication links 26. For instance, a first prioritized sequence of content items corresponding to a first type of communication link may differ from a second prioritized sequence of content items corresponding to a second type of communication link, where the difference may include one or more of the specific content items included in the respective prioritized sequence, or an order of the specific content items included in the respective prioritized sequence, or both.

Moreover, in an aspect that may work independently from or in conjunction with content delivery service 12, each wireless device 22 may include a download manager 30 that executes one or more acquisition rules 32 to control the acquisition and storage of content items 20 by the wireless device 22, such as in a memory 31. In particular, the one or more acquisition rules 32 control content acquisition according to one or more factors, such as but not limited to one or more of a user preference 34, a device parameter 36 such as available memory or available power, a content item parameter 38 such as a format or type of the content item (e.g. video, music, etc.), the type 24 of the one or more communication links 26, or any other user-specific, device-specific, content-specific, or communication link-specific attribute that may influence whether a particular content item is to be downloaded at a given instance.

Further, each wireless device 22 may further include a memory 40 for storing one or more downloaded content items 20, as well as a user interface media manager 42 for controlling presentation or acquisition of one or more content items 20 on wireless device 22.

Optionally, in an aspect, acquisition system 10 may further include a deposit manager 44, such as part of or in communication with content delivery service 12, to control obtaining one or more content items 20 from one or more content providers 46 for subsequent distribution by distribution manager 14. In an aspect, for example, content delivery service 12 includes a memory 49 that stores one or more content items 20 received from one or more content providers 46 according to one or more deposit rules 48. Deposit rules 48 may include, but are not limited to, one or more rules or factors that define one or more of a type of content, a recommended user age or maturity rating or code that identifies an intended audience for the content, an approved content provider, or any other attribute that may be used to determine if a content item 20 is acceptable to be received by and distributed within acquisition system 10.

Thus, acquisition system 10 provides content delivery service 12 that distributes, or one or more wireless devices 22 that acquire, one or more content items 20 in a push manner, which may improve efficiency in communications, at the content distribution service, or at the wireless device, by basing the push of content on one or more distribution rules 16 that control content distribution according to a type 24 of one or more available communication links 26 between content delivery service 12 and a respective wireless device 22 and according to a prioritization code 28 corresponding to each content item 20. Hence, the described aspects provide apparatus and methods that execute to distribute a prioritized sequence 18 of one or more content items 20.

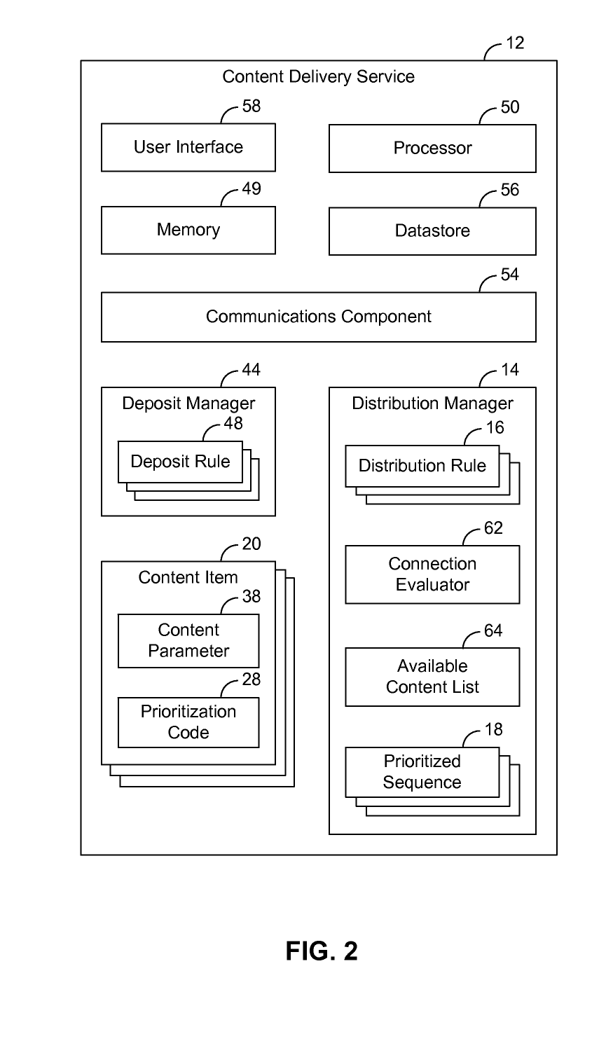

Referring to FIG. 2, in an aspect, content delivery service 12 may include or be implemented on any type of computer device, such as a network server. Content delivery service 12 includes a processor 50 for carrying out processing functions associated with one or more of components and functions of content delivery service 12 described herein. Processor 50 can include a single or multiple set of processors or multi-core processors. Moreover, processor 50 can be implemented as an integrated processing system or a distributed processing system.

Content delivery service 12 further includes memory 49, as mentioned above, such as for storing local versions of applications being executed by processor 50. Memory 49 can include any type of memory usable by a computer, such as random access memory (RAM), read only memory (ROM), tapes, magnetic discs, optical discs, volatile memory, non-volatile memory, and any combination thereof.

Further, content delivery service 12 includes a communications component 54 that provides for establishing and maintaining communications with one or more parties utilizing one or more of hardware, software, or services as described herein. Communications component 54 may carry communications between components on content delivery service 12, as well as between content delivery service 12 and external devices, such as devices located across a communications network, or devices serially or locally connected to content delivery service 12. For example, communications component 54 may include one or more buses, and may further include transmit chain components and receive chain components associated with a transmitter and receiver, respectively, or a transceiver, operable for interfacing with external devices. Further, for example, communications component 54 may include one or more communication interfaces, where each communication interface can establish and manage at least one communication link 26 (FIG. 1) with one or more wireless devices 22 (FIG. 1).

Additionally, content delivery service 12 may further include a data store 56, which can be any suitable one or combination of hardware or software, that provides for mass storage of information, databases, applications and programs employed in connection with aspects described herein. For example, data store 56 may be a data repository for applications not currently being executed by processor 50.

Content delivery service 12 may additionally include a user interface component 58 operable to receive inputs from a user of content delivery service 12, and further operable to generate outputs for presentation to the user. User interface component 58 may include one or more input devices, including but not limited to a keyboard, a number pad, a mouse, a touch-sensitive display, a navigation key, a function key, a microphone, a voice recognition component, or any other mechanism capable of receiving an input from a user, or any combination thereof. Further, user interface component 58 may include one or more output devices, including but not limited to a display, a speaker, a haptic feedback mechanism, a printer, or any other mechanism capable of presenting an output to a user, or any combination thereof.

Further, as discussed with respect to FIG. 1, content delivery service 12 includes deposit manager 44 that obtains content items 20 from content providers 46 according to one or more deposit rules 48.

Also, as discussed with respect to FIG. 1, content delivery service 12 includes one or more content items 20, each having a corresponding prioritization code 28. Each content item 20 may optionally include one or more content type data 60, such as metadata that identifies the content, provides a description or definition of the content, defines a format of the content, or any other data useful in managing or acquiring of the corresponding content item.

In an aspect, content delivery service 12 maintains the one or more content items 20 in one or more directories, enabling content delivery service 12 to function as a directory syncing system. For example, in an aspect, the directory structure at content delivery service 12 may be replicated on one or more wireless devices 22. Alternatively, there may be a set of rules executed by content delivery service 12 to dictate where each content item 20 is to be stored on one or more wireless devices 22. For example, content delivery service 12 may provide a directory identifier with each content item 20 to control which directory in the wireless device 22 to store each content item 20. As such, an application on the wireless device that is interested in using the content item only has to search a known directory, as opposed to searching the entire wireless device, to find the content item of interest to the application. In another aspect, if a content item 20 is removed from content delivery service 12, then the syncing functionality also initiates removal of the corresponding content item 20 from each wireless device 22, for example, by transmitting a removal code corresponding to each content item 20 to be removed.

Additionally, as discussed with respect to FIG. 1, content delivery service 12 includes distribution manager 14 that distributes prioritized sequence 18 of one or more content items 20 according to one or more distribution rules 16. In an aspect, distribution manager 14 may further include a connection evaluator component 62 that determines, at any given time, the available communication links 26 (FIG. 1) and their corresponding types 24 (FIG. 1). For example, connection evaluator component 62 may communicate with communications component 54 to determine this information. Further, for example, connection evaluator component 62 may consult a local or remote database to acquire the information to define the type 24 of each available communication link 26. As such, distribution manager 14 consults with connection evaluator component 62 to determine prioritized sequence 18 of one or more content items 20 based, at least in part, on the type 24 of each available communication link 26.

Moreover, in an aspect, distribution manager 14 may generate or obtain an available content list 66 that identifies the plurality of content items 20 that are available from distribution manager 14. Distribution manager 14 may periodically distribute available content list 66 to the one or more wireless devices 22. For example, distribution manager 14 may transmit available content list 66 over one or more communication links 26 so that each wireless device 22 may provide a user with an ability to select desired ones of the available content items 20 to acquire.

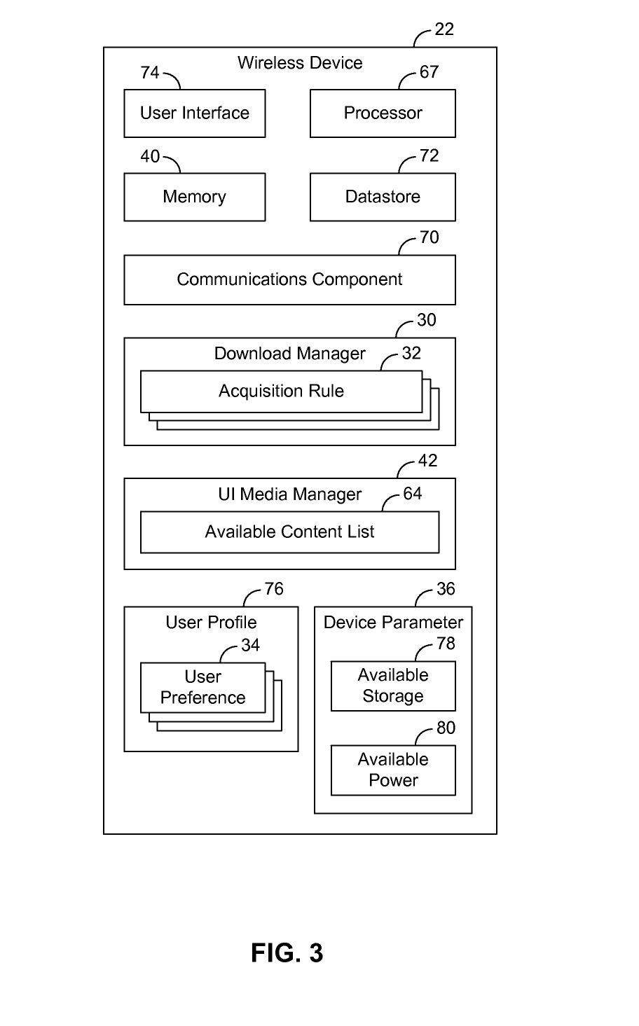

Referring to FIG. 3, in an aspect, wireless device 22 includes any type of computer device, such as a cellular phone, a personal data device, a mobile gaming device, etc. Wireless device 22 includes a processor 67 for carrying out processing functions associated with one or more of components and functions described herein. Processor 67 can include a single or multiple set of processors or multi-core processors. Moreover, processor 67 can be implemented as an integrated processing system or a distributed processing system.

Wireless device 22 further includes a memory 40, as discussed above, such as for storing local versions of applications being executed by processor 67. Memory 40 can include any type of memory usable by a computer, such as random access memory (RAM), read only memory (ROM), tapes, magnetic discs, optical discs, volatile memory, non-volatile memory, and any combination thereof.

Further, wireless device 22 includes a communications component 70 that provides for establishing and maintaining communications with one or more parties utilizing one or any combination of hardware, software, or other services as described herein. Communications component 70 may carry communications between components on wireless device 22, as well as between wireless device 22 and external devices, such as devices located across a communications network or devices serially or locally connected to wireless device 22. For example, communications component 70 may include one or more buses, and may further include transmit chain components and receive chain components associated with a transmitter and receiver, respectively, operable for interfacing with external devices. Further, for example, communications component 70 may include one or more communication interfaces, where each communication interface can establish and manage at least one communication link 26 (FIG. 1) with one or more wireless devices 22 (FIG. 1).

Additionally, wireless device 22 may further include a data store 72, which can be any suitable combination of hardware or software, that provides for mass storage of information, databases, and programs employed in connection with aspects described herein. For example, data store 72 may be a data repository for applications not currently being executed by processor 67.

Wireless device 22 may additionally include a user interface component 58 operable to receive inputs from a user of wireless device 22, and further be operable to generate outputs for presentation to the user. User interface component 58 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, user interface component 58 may include one or more output devices, including but not limited to a display, a speaker, a haptic feedback mechanism, a printer, any other mechanism capable of presenting an output to a user, or any combination thereof.

Further, as discussed with respect to FIG. 1, wireless device 22 includes a download manager 30 that downloads one or more content items 20 via one or more wireless communication links 26 according to one or more acquisition rules 32. For example, the one or more acquisition rules 32 may obtain information, such as a user preference 34 from a user profile 76, or a device parameter 36, such as available storage space 78 or available power 80, or the type 24 each available communication link 26 and analyze this information in order to determine whether to download a respective content item 20. For example, the one or more acquisition rules 32 may dictate to only download content items 20 that match a user preference 34, or that match a device parameter 36, or that are downloadable over a specific one of the types 24 of available wireless communication links 26.

In another aspect, user profile 76 may additionally include subscription information 82, such as identifiers, keys, etc., that enable wireless device 22 to acquire one or more content items 20 from content delivery service 12.

Additionally, in an aspect, wireless device 22 may further include user interface media manager 42, as mentioned above, which allows user interaction to control acquisition and presentation of one or more content items 20.

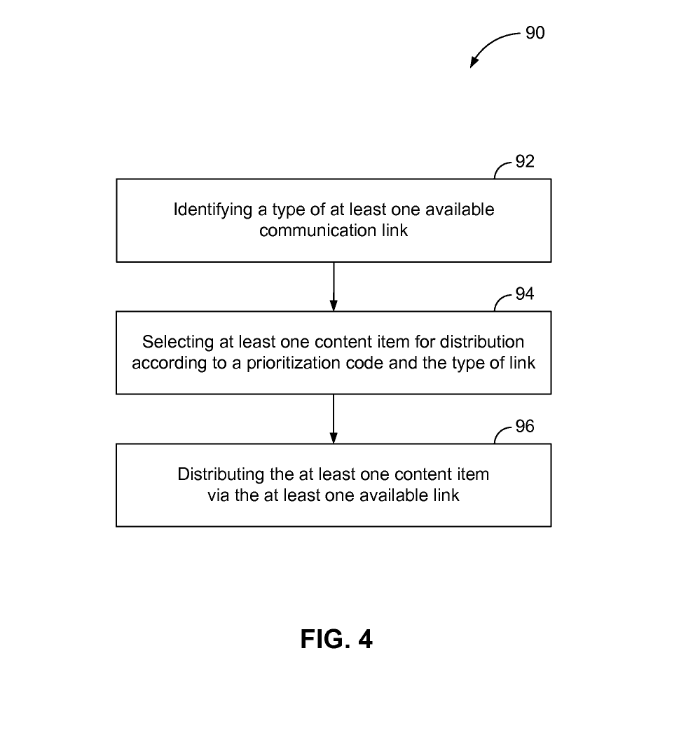

Referring to FIG. 4, in an aspect, a method 90 of distributing content, such as by a content delivery service, comprises identifying a type of at least one available wireless communication link (Block 92). For example, in one non-limiting aspect, connection evaluator component 62 (FIG. 2) may consult with communications component 54 to determine each type 24 of one or more available wireless communication links 26 (FIG. 1).

The method 90 further includes selecting at least one content for distribution based on a distribution rule that prioritizes the distribution of the content according to a prioritization code corresponding to the content and according to the type of the at least one available wireless communication link (Block 94). For example, in one non-limiting aspect, distribution manager 14 may execute one or more distribution rules 16 to generate prioritized sequence 18 of one or more content items 20 based on their respective prioritization code 28 and based on the type 24 of the one or more available wireless communication links 26 (FIG. 1).

For example, in an aspect, the at least one available wireless communication link comprises one of a plurality of available wireless communication links each having a corresponding type, wherein each type includes a cost parameter, and the selecting comprises selecting the at least one available wireless communication link from the plurality of available wireless communication links according to a corresponding cost parameter.

In another aspect, the at least one content comprises one of a plurality of content for distribution, and the selecting further comprises selecting a second one of the plurality of content for distribution on a second one of the plurality of available wireless communication links based on a respective prioritization code corresponding to the second one of the plurality of content and according to a respective type of the second one of the plurality of available wireless communication links.

In a further aspect, wherein the at least one content comprises one of a plurality of content for distribution, the selecting further comprises selecting each of the plurality of content for distribution in a specific order on the at least one available wireless communication link based on a respective prioritization code corresponding to each of the plurality of content.

In yet another aspect, the selecting may further include determining not to distribute a second one of the plurality of content on any of the plurality of available wireless communication links based on a respective prioritization code corresponding to the second one of the plurality of content and according to each type of the plurality of available wireless communication links.

Also, the method 90 further includes distributing the at least one content via the at least one available wireless communication link (Block 96). For example, in one non-limiting aspect, distribution manager 14 transmits prioritized sequence 18 of one or more content items 20 over the one or more available wireless communication links 26.

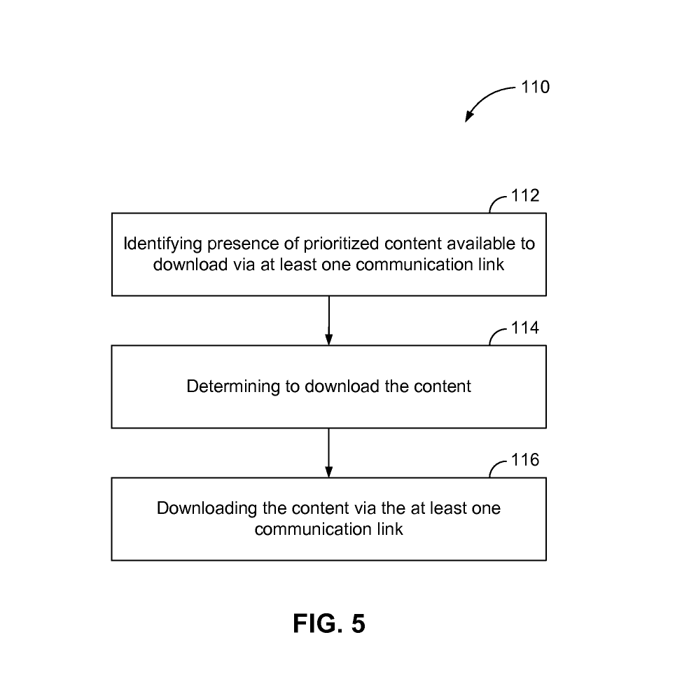

Referring to FIG. 5, in an aspect, a method 110 of acquiring content, such as may be executed by a mobile device, comprises identifying a presence of content to download via at least one wireless interface (Block 112), wherein the content to download is available via the at least one wireless interface based on a distribution rule that prioritizes a distribution of the content according to a prioritization code and according to a type of a wireless communication link corresponding to the at least one wireless interface. For example, in one non-limiting aspect, on wireless device 22 (FIG. 4), download manager 30 may consult with communications component 70 to determine available ones of one or more wireless communication links 26. Further, download manager 30 may monitor communication links 26 for transmissions of prioritized sequence 18 of one or more content items 20 from content delivery service 12 (FIG. 1).

The method 110 further includes determining to download the content via the at least one wireless interface (Block 114). For example, in one non-limiting aspect, download manager 30 executes one or more acquisition rules 32 to compare parameters of the content items or links with user preferences or device capabilities in order to find matches that indicate a content item is suitable for downloading.

Also, the method 110 includes downloading the content via the at least one wireless interface (Block 116). For example, in one non-limiting aspect, download manager 30 initiates the receiving and storage of one or more content items 20, such as in memory 40 of wireless device 22. As such, the stored content items are then subsequently available for presentation to a user of the wireless device 22. In another aspect, download manager 30 may receive a content index that identifies the content, receive a user selection of the content from the content index, and retrieve the content from a memory on a device if the content is stored in the memory, or download manager 30 may initiate downloading of the content if the content is not stored in the memory.

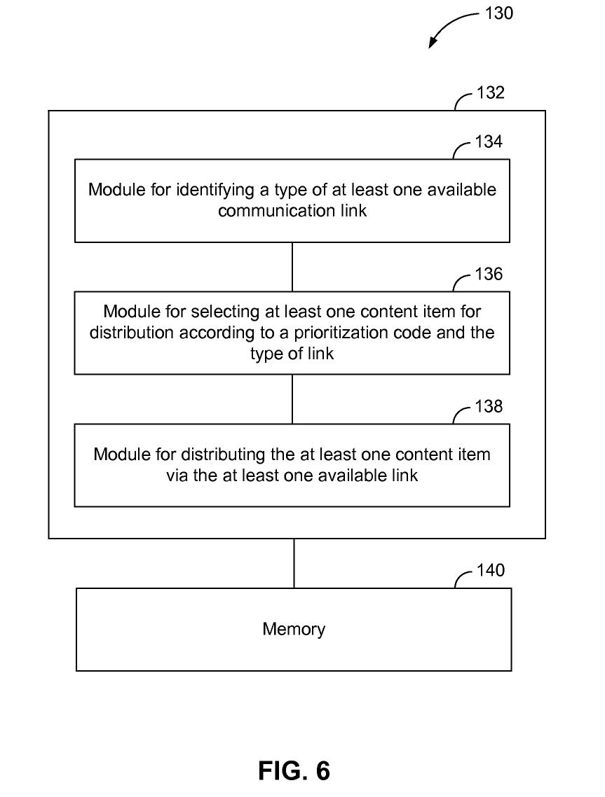

Referring to FIG. 6, in an aspect, an apparatus 130 that receives and distributes content items may reside at least partially within a network component, such as a network server. It is to be appreciated that apparatus 130 is represented as including functional blocks, which can be functional blocks that represent functions implemented by a processor, software, or combination thereof (e.g., firmware). Apparatus 130 includes a logical grouping 132 of electrical components that can act in conjunction. For instance, logical grouping 132 can include a module or electrical component 134 for identifying a type of at least one available wireless communication link.

Further, logical grouping 132 can comprise a module or electrical component 136 for selecting at least one content for distribution based on a distribution rule that prioritizes the distribution of the content according to a prioritization code corresponding to the content and according to the type of the at least one available wireless communication link. Furthermore, logical grouping 132 can comprise a module or electrical component 138 for distributing the at least one content via the at least one available wireless communication link.

Additionally, apparatus 130 can include a memory 140 that retains instructions for executing functions associated with electrical components 134, 136, and 138. While shown as being external to memory 140, it is to be understood that one or more of electrical components 134, 136, and 138 can exist within memory 140.

Referring to FIG. 6, in an aspect, an apparatus 150 that acquires and presents content items may reside at least partially within mobile device, such as a wireless communication device. It is to be appreciated that apparatus 150 is represented as including functional blocks, which can be functional blocks that represent functions implemented by a processor, software, or combination thereof (e.g., firmware). Apparatus 150 includes a logical grouping 152 of electrical components that can act in conjunction. For instance, logical grouping 152 can include a module or electrical component 154 for identifying a presence of content to download via at least one wireless interface, wherein the content to download is available via the at least one wireless interface based on a distribution rule that prioritizes a distribution of the content according to a prioritization code and according to a type of a wireless communication link corresponding to the at least one wireless interface.

Further, logical grouping 152 can comprise a module or electrical component 156 for determining to download the content via the at least one wireless interface. Furthermore, logical grouping 152 can comprise a module or electrical component 158 for downloading the content via the at least one wireless interface.

Additionally, apparatus 150 can include a memory 160 that retains instructions for executing functions associated with electrical components 154, 156, and 158. While shown as being external to memory 160, it is to be understood that one or more of electrical components 154, 156, and 158 can exist within memory 160.

As previously described with regard to FIG. 1, prioritization by the content delivery system 12 can be made in accordance with one or more factors, such as storage space 78, power 80, user preferences 34, and type of communication link 26. It should be appreciated with the benefit of the present disclosure that the content delivery system 12 can dynamically address interruptions in distribution as well as other changes in the afore-mentioned factors as well as others. In particular, prioritization of distribution of content can depend on one or more factors including (a) user interest; (b) subscription status; (c) channel cost; and (d) device limitation(s) (e.g., memory storage, battery service life, etc.). Also as previously disclosed, in an exemplary aspect mass distribution (e.g., one-to-many transmission) can be employed for network efficiency to mobile devices that cache content items. It is contemplated that partial delivery warranted by network considerations, device limitations, or user preferences, can be followed by completion of delivery when priority for a content item changes. In particular, one of several delivery channels can be employed to optimize the delivery from the point of the view of a mobile device or the network.

For example, a broadcast channel or cellular multi-cast can be used. A secondary transmission for completing distribution of a content item can be employed for mobile devices that did not receive the entire content item. For instance, the secondary transmission can be another one-to-many transmission, in particular a chain reaction encoded (described below) portion of the content item, to avoid having to fully re-transmit the content item. Alternatively or in addition, the secondary transmission can be an unlocking component (e.g., subscription code, data rights management authentication, etc.). Alternatively or in addition, the secondary transmission can be a one-to-one re-transmission to satisfy the needs of a particular mobile device, such as deferred until a low cost type of link is available (e.g., WiFi).

In one aspect, distribution that is responsive to user patterning and consumption can further be responsive to selective or changing circumstances as to one or more paths that can be used to complete distribution, in either a one-to-many (e.g., broadcast, multicast) or unicast fashion, to one or more devices. For instance, delivering via a broadcast at least in part can be an efficient approach from a perspective of a network for content distribution. Going through multiple networks and delivering ad hoc from devices that are proximate to a device (e.g., creating a location to an extent) can be coupled with this network efficiency to ensure that individual needs are satisfied without an undue burden to the network.

Coupling the needs for mass distribution while satisfying individual prioritization can be achieved in an exemplary aspect by use of encoding that allows less message traffic and individualized retransmissions. To that end, the present disclosure provides for decoding information additive codes and multi-stage information additive codes, herein referred to collectively as “chain reaction codes.”

Chain reaction codes have been described previously in the assignee's patents, such as U.S. Pat. No. 6,307,487 entitled “Information Additive Code Generator and Decoder for Communication Systems”, and U.S. Pat. No. 7,068,729, entitled “Multi-Stage Code Generator and Decoder for Communication Systems” (hereinafter “Raptor”). As described therein, chain reaction decoding is a unique form of Forward Error-Correction (FEC) that enables data reconstruction from a received data set of a given size, without regard to the particular data packets received. Communication systems employing chain reaction codes are able to communicate information much more efficiently compared to traditional FEC codes transmitted via data carousel or acknowledgement-based protocols, as described in Luby I or Raptor, as provided below.

In an exemplary aspect, Raptor encoding provides a method of encoding data for transmission from a source to a destination over a communications channel. A plurality of redundant symbols are generated from an ordered set of input symbols to be transmitted. A plurality of output symbols are generated from a combined set of symbols including the input symbols and the redundant symbols. The number of possible output symbols is much larger than the number of symbols in the combined set of symbols. Furthermore, at least one output symbol is generated from more than one symbol in the combined set of symbols and from less than all of the symbols in the combined set of symbols, such that the ordered set of input symbols can be regenerated to a desired degree of accuracy from any predetermined number, N, of the output symbols.

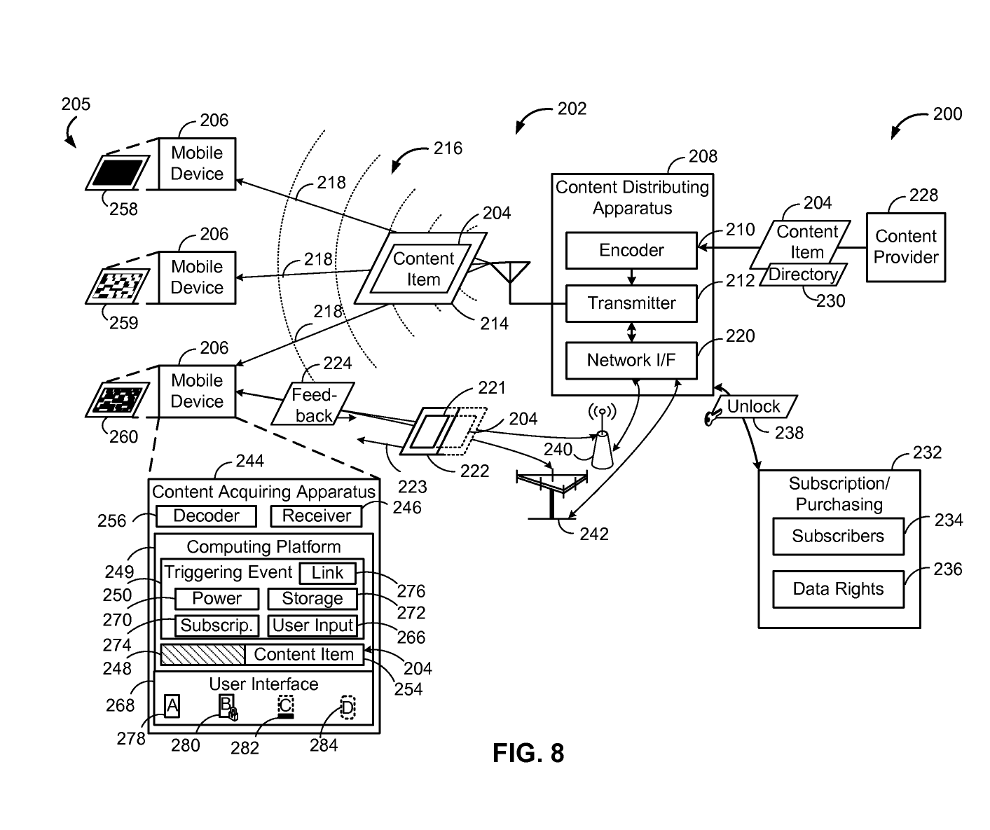

Returning to the Drawings, in FIG. 8 a content distribution system 200 operates on a communication network 202 to distribute content items 204 to a population of communication devices 205, which can comprise mobile devices 206. As part of the communication network 202, an apparatus 208 for distributing content comprises an encoder 210 for chain reaction encoding of a content item 204. A transmitter 212 transmits the content item 204 as encoded packets 214 via a one-to-many transmission 216 (e.g., broadcast, cellular multi-cast, etc.) from a first link 218 to the population of mobile devices 206. A network interface 220 retransmits at least a portion 221 of the content item 204 as encoded packets 222 via a second transmission 223, which can be a one-to-many or one-to-one transmission. The network interface 220 can determine what portion to retransmit based upon feedback 224 received from at least a subset of the population of mobile devices 206.

In an exemplary aspect, the encoder 210 of the apparatus 208 may be a chain reaction encoder (e.g., Raptor code) to more efficiently broadcast or multi-cast the content items 204 in situations in which the reception can be lossy or mobile devices 206 may be temporarily out of service or otherwise inactive. A content provider 228 can specify a directory structure 230 that is conveyed with the content item 204.

The content distribution system 200 can encompass or interface with a subscription or purchasing system 232 that tracks subscribers 234 or data management rights 236 for content items 204 and provides an unlocking component 238 (e.g., subscription code, decryption key, etc.).

The second transmission 223 can utilize the same access technology as the first one-to-many transmission 216. Alternatively or in addition, a mobile device 206 can utilize a second type of link, depicted first as an access point 240 (e.g., WLAN) that can provide cost efficient data throughput. Alternatively or in addition, the mobile device 206 can utilize a cellular network 242.

One of the mobile devices 206 is depicted as including an apparatus 244 for acquiring a content item 204 by using a receiver 246 for receiving a first portion 248 of the content item 204 from a first link, depicted as the one-to-many transmission 216. A computing platform 249 detects a triggering event 250 for the content item 204. The receiver 252 further accesses a second portion 254 of the content item 204 via a second transmission, depicted as either the second transmission 223, the unlocking component 238, access point 240, or cellular network 242. For example, the device may be operable for receiving a first portion of a content item and subsequently receiving the second portion of a content item. For example, the subsequent receiving of the second portion of the content item may be based on initially failing to receive the second portion of the content item via the one-to-many transmission of the content item, or the subsequent receiving of the second portion of the content item may be based on deferring storage of the second portion of a content item due to prioritization of the content item.

In an exemplary aspect, the apparatus 244 for acquiring content can utilize a decoder 256 for chain reaction decoding (e.g., Raptor code). For example, different mobile devices 206 can each receive a different portion of the content item 204, as depicted at 258-260. Without necessarily sending the exact same respective portions, receiving Raptor code encoded portion in proportion to the amount missed can complete the distribution of the content item 204.

The computing platform 249 detects the triggering event 250 as a selected one or more of a number of factors. For instance, the trigger event 250 can be, at least in part, a user input 266 to a user interface 268 associated with the content item 204. For another instance, the trigger event 250 can be, at least in part, a change in a device parameter associated with capacity to receive the content item 204 depicted as power level 270 and available storage 272. For an additional instance, the trigger event 250 can be, at least in part, the availability of a subscription 274 for the content item 204. For yet another instance, the trigger event 250 can be, at least in part, an availability of a type of link 276 for receiving the second portion 254 of the content item 204.

To facilitate the user input 266, the user interface 268 can be for indicating a status for accessibility of the content item 204 by displaying an annotation or icon for the content indicating a selected one of stored for use, pending access upon acquiring a selected type of link, and access pending user selection. For example, a first icon 278 indicates content item 204 that is fully available on the apparatus 244 for consumption or use (e.g., in a standalone mode). A second icon 280 indicates a content item 204 that is downloaded or cached but requires activation (e.g., acquiring license or subscription rights). A third icon 282 indicates a content item 204 that was partially downloaded and cached, requiring a second attempt or other link to complete such as from a second access network or node (e.g., Raptor coded retransmission). A fourth icon 284 indicates a content item 204 that was not cached due to a determined low priority but could be elevated in priority upon user selection. Alternatively, some of these categories of content icons can be accessed in a menu-driven, hierarchical or faceted search manner wherein a particular screen provides other groupings to indicate a status for download and use.

In use, a caching service can utilize content applications that are packaged as part of the operating system or provided by content providers. For instance, a content application can act as installer, looking to what content is locally stored first before pulling remote content to a mobile device. Alternatively or in addition, application installers would also be delivered to the device with the content. Applications or other content provisioned on the mobile device, distributed by a caching service, or retrieved by the content application or application installer can utilize a cellular or other remote link as well as a manual authorization code entry. Syncing can stop if there is no storage left on the mobile device or prioritization can be used to selectively overwrite existing content.

In an illustrative operational concept for a caching service, any data delivered to the server is delivered to a target directory on the mobile device which is specified by the content provider on the server. The caching service can sync up the server side content directory with the device side content directory. The content provider delivers the content to the server and this content is delivered seamlessly to the mobile device through one of several paths. Each path can have a distinct subscription cost and priority. For instance, a lower priority path is utilized if a higher priority path is not available or upon selection by the user to expedite delivery. Moreover, each path itself can comprise primary and secondary paths, etc., specified for use in the event of failure of a path.

The mobile device can track which cache directories are used by the user and then stop syncing those directories that are not used by the user to conserve memory storage and battery life or reduce a subscription cost. In addition the user can mark directories that should not be synced and directories that should be synced. Content that is already on the device will not be attempted to be synced. An index can be accessed by the user to see all of the content that is available for syncing. In some instances, content can be designated that should be deleted from a server for future syncing or that should be deleted from mobile devices. For instance, a subscription right to consume content can expire. The caching system can implement caching of content dependent upon receiving an indication from a connectivity application based on connection availability and business rules. For example, a business rule can limit caching to only when Wi-Fi is available. As another example, cellular access to caching can be limited to one-to-many broadcasting or multicasting with chain reaction coding employed for efficient retransmissions.

Each different content provider can have their login account that specifies the name of the directory that would be created on each mobile device as part of the caching system. The directory structure on the server could be replicated on the mobile device. The content provider can get statistical information (e.g., a histogram) regarding content distribution to a population of mobile devices. Thereby, the content providers can determine the success of the content distribution.

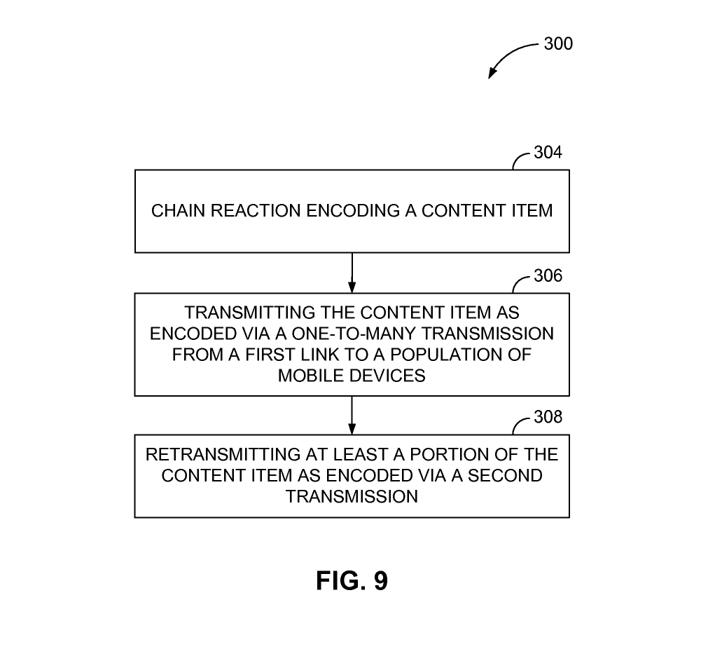

In FIG. 9, the present disclosure provides a methodology 300 for distributing content by chain reaction encoding (e.g., Raptor code) a content item (block 304). The methodology 300 further provides transmitting the content item as encoded packets via a one-to-many transmission from a first link to a population of mobile devices (block 306). The methodology 300 further provides retransmitting at least a portion of the content item as encoded packets via a second transmission (block 308). The retransmission can be a one-to-many transmission or a one-to-one transmission. The retransmission can be in response to determining that a subset of the population of mobile devices failed to receive the content item. The chain reaction encoding can indicate an intended destination directory for cache storage of the content item on each of the population of mobile devices.

Provisions can include integrating purchasing and subscription services. To that end, the methodology 300 can provide wherein retransmitting the at least the portion of the content item further comprises transmitting an unlocking component for the content item. In particular, transmitting the unlocking component for the content item can be achieved by accessing the unlocking component from a purchasing system and transmitting the second transmission from a cellular network.

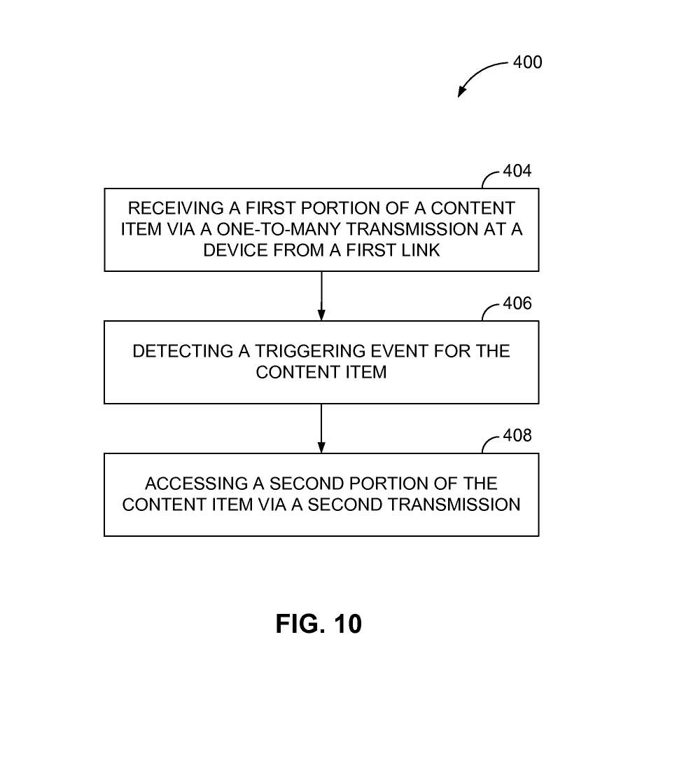

In FIG. 10, the present disclosure provides a methodology 400 for acquiring content by receiving a first portion of a content item via a one-to-many transmission at a device from a first link (block 404). The methodology 400 further provides detecting a triggering event for the content item (block 406). The methodology 400 further provides accessing a second portion of the content item via a second transmission (block 408). The second portion can be accessed via a one-to-many or a one-to-one transmission. In an exemplary aspect, the first and second portions are sent with chain reaction encoding (e.g., Raptor code).

The triggering event for accessing the second portion of the content item can be at least one of a user input associated with the content item, a change in a device parameter associated with capacity to receive the content item, availability of a subscription for the content item, or availability of a type of link for receiving the second portion of the content item.

In order to receive the user input, a user interface can be provided for indicating a status for accessibility of the content item (e.g., displaying an annotation or icon for the content item indicating a selected one of stored for use, pending access upon acquiring a selected type of link, and access pending user selection). Further, the indications can be displayed representative for the first portion received and the second portion not received of the content item. For instance, a relatively small amount of the content item not accessed via a one-to-many transmission can warrant a one-to-one retransmission (e.g., cellular) whereas a large amount not yet accessed can warrant an alternative, deferred access (e.g., WiFi).

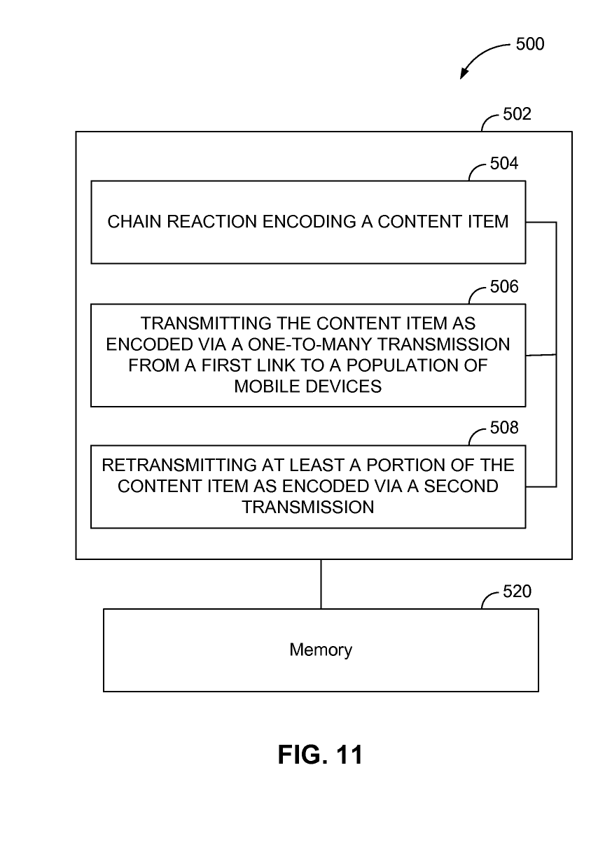

With reference to FIG. 11, illustrated is a system 500 for distributing content. For example, system 500 can reside at least partially within a network entity (e.g., evolved base node). It is to be appreciated that system 500 is represented as including functional blocks, which can be functional blocks that represent functions implemented by a computing platform, processor, software, or combination thereof (e.g., firmware). System 500 includes a logical grouping 502 of electrical components that can act in conjunction. For instance, logical grouping 502 can include an electrical component 504 for chain reaction encoding a content item. Moreover, logical grouping 502 can include an electrical component 506 for transmitting the content item as encoded via a one-to-many transmission from a first link to a population of mobile devices. Moreover, logical grouping 502 can include an electrical component 508 for retransmitting at least a portion of the content item as encoded via a second transmission. Additionally, system 500 can include a memory 520 that retains instructions for executing functions associated with electrical components 504-508. While shown as being external to memory 520, it is to be understood that one or more of electrical components 504-508 can exist within memory 520.

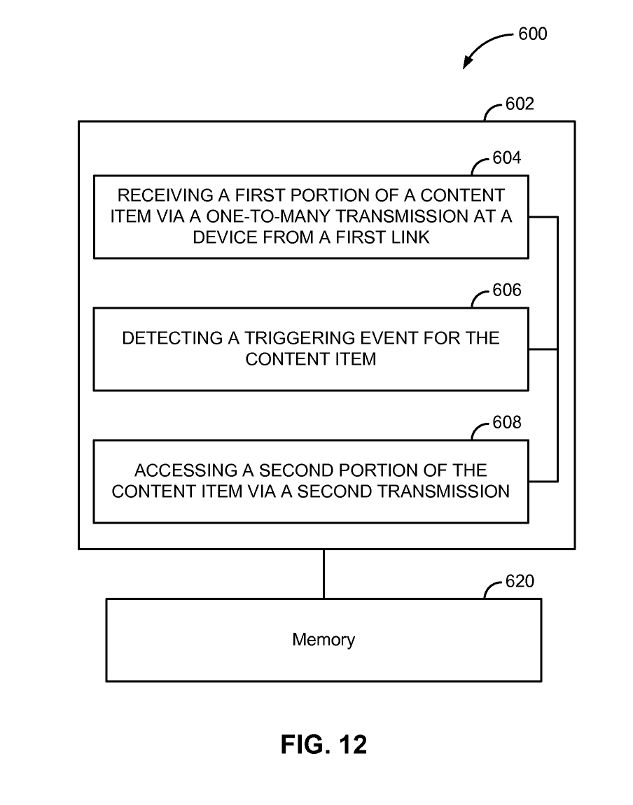

With reference to FIG. 12, illustrated is a system 600 for acquiring content. For example, system 600 can reside at least partially within user equipment (UE) or mobile device. It is to be appreciated that system 600 is represented as including functional blocks, which can be functional blocks that represent functions implemented by a computing platform, processor, software, or combination thereof (e.g., firmware). System 600 includes a logical grouping 602 of electrical components that can act in conjunction. For instance, logical grouping 602 can include an electrical component 604 for receiving a first portion of a content item via a one-to-many transmission at a device from a first link. Moreover, logical grouping 602 can include an electrical component 606 for detecting a triggering event for the content item. In addition, logical grouping 602 can include an electrical component 608 for detecting a triggering event for the content item. Additionally, system 600 can include a memory 620 that retains instructions for executing functions associated with electrical components 604-608. While shown as being external to memory 620, it is to be understood that one or more of electrical components 604-608 can exist within memory 620.

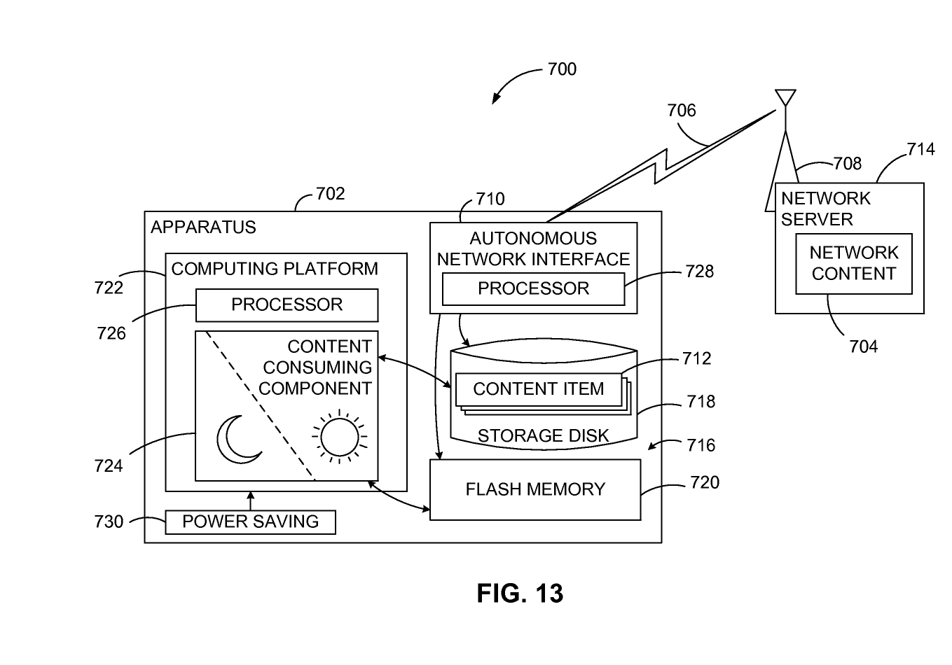

In FIG. 13, in a communication system 700, an apparatus 702, such as user equipment, a data processing system, a mobile device, etc., acquires network content 704 over a wireless or over-the-air link 706 in a mobile environment. In an illustrative aspect, a radio access network 708 transmits selectively transmits network content 704 via a one-to-many transmission such as Evolved Multimedia Broadcast Multicast Service (eMBMS). eMBMS is a transmission service that can simultaneously send the same combined media signals (such as video and audio) to multiple recipients in the same geographic region using Universal Mobile Telecommunications System (UMTS) Long Term Evolution (LTE) evolved Base Nodes (eNBs) or base stations.

An autonomous network interface 710 at the apparatus 702 receives a content item 712 of the network content 704 from a network server 714. The autonomous network interface 710 caches the content item 712 in a computer-readable storage medium 716, which can include a storage disk 718. Alternatively or in addition, the computer-readable storage medium can include flash memory 720.

A computing platform 722 of the apparatus 702 executes a content consuming component 724 that can use, play, modify, present, or otherwise interact with the content item 712. For example, the computing platform 722 can access the same computer-readable storage medium 716 as the autonomous network interface 710. Alternatively, at least one processor 726 of the computing platform 722 can communicate with at least one processor 728 of the autonomous network interface 710 for requesting and obtaining the content item 712 for use, etc.

The autonomous network interface 710 can operate to receive the content item 712 during periods in which a portion of the apparatus 702 is deactivated, such as depicted by a power-saving control 730 suspending operation of the computing platform 722. Thus, an embedded or attached cellular network interface can perform caching when a supported user device sleeps or is turned off.

Alternatively or in addition, the autonomous network interface 710 can serve as a scavenger class implementation, utilizing a type or particular resources of radio access network 708 that is not being used by the computing platform 722. For example, a communication device can have wireless capability when running. The autonomous network interface 710 can acquire another radio access network in order to avoid or mitigate degradation of a higher priority data transmission by the computing platform 722.

The autonomous network interface 710 can address the Quality of Service (QoS) treatment of scavenger traffic. The scavenger class is intended to provide deferential services, or less-than best-effort services, to certain applications. Applications assigned to this class have little or no contribution to the organizational objectives of the enterprise and are typically entertainment oriented in nature. These include peer-to-peer media-sharing applications, gaming applications, and any entertainment video applications. Scavenger traffic can be assigned the lowest configurable queuing service. Assigning scavenger traffic to minimal bandwidth queue forces it to be squelched to virtually nothing during periods of congestion, but allows use of available bandwidth when not being used for business purposes, such as might occur during off-peak hours or when the computing platform 722 is in standby mode. The autonomous network interface 710 can support battery and storage optimization as well as content security.

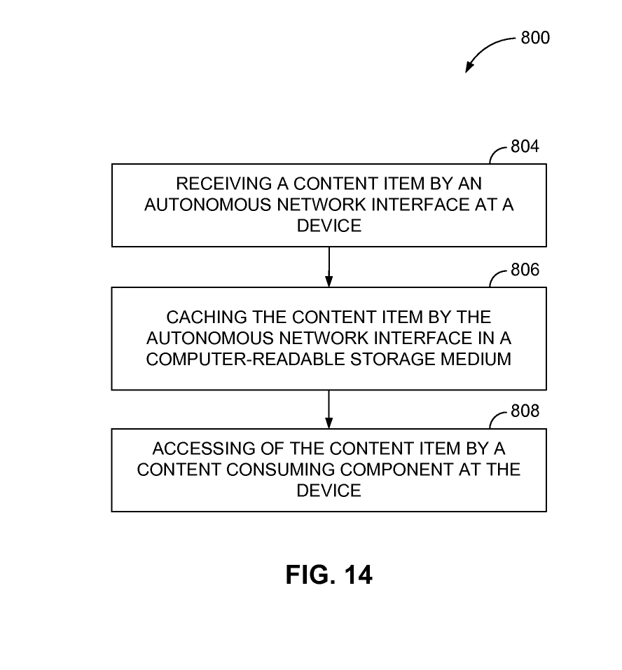

In FIG. 14, a methodology 800 is depicted for acquiring content in a mobile environment. Receiving a content item by an autonomous network interface at a device is depicted in block 804. In an exemplary aspect, the content item is transmitted from a network via a one-to-many transmission, although the content item could also be requested in a one-to-one communication session. Caching the content item by the autonomous network interface in a computer-readable storage medium is depicted in block 806. Accessing of the content item by a content consuming component at the device is depicted in block 808. In an exemplary aspect, this access is subsequent to suspending operation of a computing platform that executes the content consuming component while receiving the content item by the autonomous network interface.

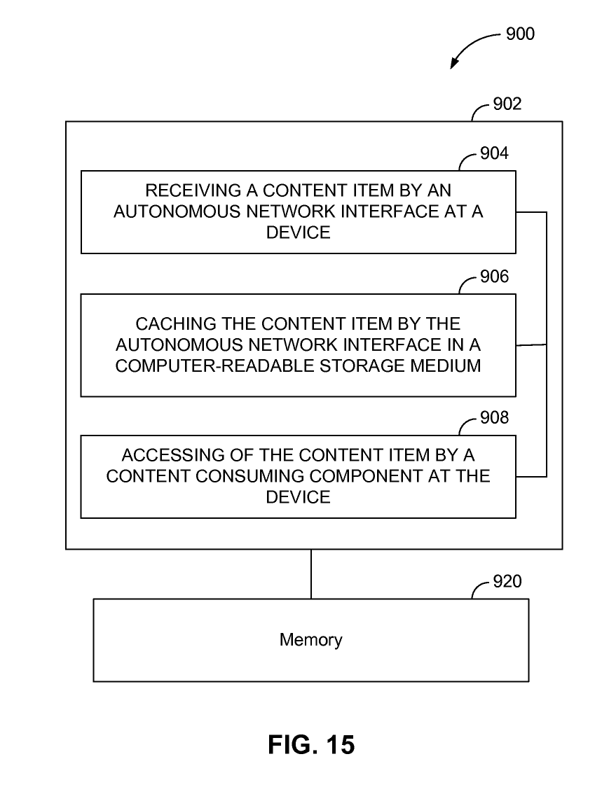

Referring to FIG. 15, in an aspect, an apparatus 900 that acquires and presents content items may reside at least partially within mobile device, such as a wireless communication device. It is to be appreciated that apparatus 900 is represented as including functional blocks, which can be functional blocks that represent functions implemented by a processor, software, or combination thereof (e.g., firmware). Apparatus 900 includes a logical grouping 902 of electrical components that can act in conjunction. For instance, logical grouping 902 can include a module or electrical component 904 for receiving a content item by an autonomous network interface at a device. For an additional instance, logical grouping 902 can include a module or electrical component 906 for caching the content item by the autonomous network interface in a computer-readable storage medium. For another instance, logical grouping 902 can include a module or electrical component 908 for accessing of the content item by a content consuming component at the device. Additionally, apparatus 900 can include a memory 920 that retains instructions for executing functions associated with electrical components 904-908. While shown as being external to memory 920, it is to be understood that one or more of electrical components 904-908 can exist within memory 920.

Those of skill would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a server and the server can be a component. One or more components may reside within a process or thread of execution and a component may be localized on one computer or distributed between two or more computers.

The word “exemplary” is used herein to mean serving as an example, instance, or illustration. Any aspect or design described herein as “exemplary” is not necessarily to be construed as preferred or advantageous over other aspects or designs.

Various aspects have been presented in terms of systems that may include a number of components, modules, and the like. It is to be understood and appreciated that the various systems may include additional components, modules, etc. or may not include all of the components, modules, etc. discussed in connection with the figures. A combination of these approaches may also be used. The various aspects disclosed herein can be performed on electrical devices including devices that utilize touch screen display technologies or mouse-and-keyboard type interfaces. Examples of such devices include computers (desktop and mobile), smart phones, personal digital assistants (PDAs), and other electronic devices both wired and wireless.

In addition, the various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Furthermore, the one or more aspects may be implemented as a method, apparatus, or article of manufacture using standard programming or engineering techniques to produce software, firmware, hardware, or any combination thereof to control a computer to implement the disclosed aspects. These aspects may be implemented in an “article of manufacture” or alternatively, a “computer program product”, which as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope of the disclosed aspects.

The steps of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed aspects is provided to enable any person skilled in the art to make or use the present disclosure. Various modifications to these aspects will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

In view of the exemplary systems described supra, methodologies that may be implemented in accordance with the disclosed subject matter have been described with reference to several flow diagrams. While for purposes of simplicity of explanation, the methodologies are shown and described as a series of blocks, it is to be understood and appreciated that the claimed subject matter is not limited by the order of the blocks, as some blocks may occur in different orders or concurrently with other blocks from what is depicted and described herein. Moreover, not all illustrated blocks may be required to implement the methodologies described herein. Additionally, it should be further appreciated that the methodologies disclosed herein are capable of being stored on an article of manufacture to facilitate transporting and transferring such methodologies to computers. The term article of manufacture, as used herein, is intended to encompass a computer program product accessible from any computer-readable device, carrier, or media.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein, will only be incorporated to the extent that no conflict arises between that incorporated material and the existing disclosure material.

What is claimed is:

1. A method for distributing content, comprising:
identifying a type of at least one available wireless communication link;
selecting at least one content for distribution based on a distribution rule that prioritizes the distribution of the content according to a prioritization code corresponding to the content and according to the type of the at least one available wireless communication link; and
distributing the at least one content via the at least one available wireless communication link.

2. At least one processor for distributing content, comprising:
a first module for identifying a type of at least one available wireless communication link;
a second module for selecting at least one content for distribution based on a distribution rule that prioritizes the distribution of the content according to a prioritization code corresponding to the content and according to the type of the at least one available wireless communication link; and
a third module for distributing the at least one content via the at least one available wireless communication link.

3. A computer program product for distributing content, comprising:
a non-transitory computer-readable storage medium for storing instructions:
at least one instruction for causing a computer to identify a type of at least one available wireless communication link;
at least one instruction for causing the computer to select at least one content for distribution based on a distribution rule that prioritizes the distribution of the content according to a prioritization code corresponding to the content and according to the type of the at least one available wireless communication link; and
at least one instruction for causing the computer to distribute the at least one content via the at least one available wireless communication link.

4. An apparatus for distributing content, comprising:
means for identifying a type of at least one available wireless communication link;
means for selecting at least one content for distribution based on a distribution rule that prioritizes the distribution of the content according to a prioritization code corresponding to the content and according to the type of the at least one available wireless communication link; and
means for distributing the at least one content via the at least one available wireless communication link.

5. A content distribution apparatus, comprising:
a distribution manager to:
identify a type of at least one available wireless communication link;
select at least one content for distribution based on a distribution rule that prioritizes the distribution of the content according to a prioritization code corresponding to the content and according to the type of the at least one available wireless communication link; and
distribute the at least one content via the at least one available wireless communication link.

6. The content distribution apparatus of claim 5, wherein the at least one available wireless communication link comprises one of a plurality of available wireless communications links each having a corresponding type, wherein each type includes a cost parameter, and wherein the distribution manager is further to select the at least one available wireless communication link from the plurality of available wireless communication links according to a corresponding cost parameter.

7. The content distribution apparatus of claim 6, wherein the prioritization code comprises one of a plurality of different prioritization codes associated with the at least one content, wherein each of the plurality of different prioritization codes corresponds to the respective cost parameter of one of the plurality of available wireless communications links.

8. The content distribution apparatus of claim 6, wherein the at least one content comprises one of a plurality of content for distribution, and wherein the distribution manager is further to select a second one of the plurality of content for distribution on a second one of the plurality of available wireless communication links based on a respective prioritization code corresponding to the second one of the plurality of content and according to a respective type of the second one of the plurality of available wireless communication links.

9. The content distribution apparatus of claim 6, wherein the at least one content comprises one of a plurality of content for distribution, and wherein the distribution manager is further to select each of the plurality of content for distribution in a specific order on the at least one available wireless communication link based on a respective prioritization code corresponding to each of the plurality of content.

10. The content distribution apparatus of claim 6, wherein the at least one content comprises one of a plurality of content for distribution, and wherein the distribution manager is further to determine not to distribute a second one of the plurality of content on any of the plurality of available wireless communication links based on a respective prioritization code corresponding to the second one of the plurality of content and according to each type of the plurality of available wireless communication links.

11. The content distribution apparatus of claim 5, wherein the distribution manager is further to:
receive a second content for distribution; and
determine to store the second content according to a content acquisition rule.

12. The content distribution apparatus of claim 5, wherein the prioritization code corresponds to a fee.

13. The content distribution apparatus of claim 5, wherein the distributing comprises a one-to-many transmission.

14. A method for acquiring content on a mobile device, comprising:
identifying a presence of content to download via at least one wireless interface, wherein the content to download is available via the at least one wireless interface based on a distribution rule that prioritizes a distribution of the content according to a prioritization code and according to a type of a wireless communication link corresponding to the at least one wireless interface;
determining to download the content via the at least one wireless interface; and
downloading the content via the at least one wireless interface.

15. At least one processor for acquiring content on mobile device, comprising:
identifying a presence of content to download via at least one wireless interface, wherein the content to download is available via the at least one wireless interface based on a distribution rule that prioritizes a distribution of the content according to a prioritization code and according to a type of a wireless communication link corresponding to the at least one wireless interface;
determining to download the content via the at least one wireless interface; and
downloading the content via the at least one wireless interface.

16. A computer program product for acquiring content on a mobile device, comprising:
a non-transitory computer-readable storage medium for storing instructions comprising:
at least one instruction for causing a computer to identify a presence of content to download via at least one wireless interface, wherein the content to download is available via the at least one wireless interface based on a distribution rule that prioritizes a distribution of the content according to a prioritization code and according to a type of a wireless communication link corresponding to the at least one wireless interface;
at least one instruction for causing the computer to determine to download the content via the at least one wireless interface; and
at least one instruction for causing the computer to download the content via the at least one wireless interface.

17. An apparatus for acquiring content on a mobile device, comprising:
means for identifying a presence of content to download via at least one wireless interface, wherein the content to download is available via the at least one wireless interface based on a distribution rule that prioritizes a distribution of the content according to a prioritization code and according to a type of a wireless communication link corresponding to the at least one wireless interface;
means for determining to download the content via the at least one wireless interface; and
means for downloading the content via the at least one wireless interface.

18. An apparatus, comprising:
a download manager to:
identify a presence of content to download via at least one wireless interface, wherein the content to download is available via the at least one wireless interface based on a distribution rule that prioritizes a distribution of the content according to a prioritization code and according to a type of a wireless communication link corresponding to the at least one wireless interface;
determine to download the content via the at least one wireless interface; and
download the content via the at least one wireless interface.

19. The apparatus of claim 18, wherein the at least one wireless interface corresponds to one of a plurality of available wireless communications links each having a corresponding type, wherein each type includes a cost parameter, and wherein the download manager is further to select the at least one wireless interface from a plurality of available wireless interfaces according to a corresponding cost parameter.

20. The apparatus of claim 19, wherein the prioritization code comprises one of a plurality of different prioritization codes associated with a content item, wherein each of the plurality of different prioritization codes corresponds to the respective cost parameter of one of the plurality of available wireless communications links.

21. The apparatus of claim 19, wherein the content comprises one of a plurality of content for distribution, and wherein the download manager is further to download the plurality of content in an order based on a respective prioritization code corresponding to each of the plurality of content.

22. The apparatus of claim 21, wherein the order is based on the type of the one of the plurality of available wireless communication link.

23. The apparatus of claim 19, wherein the content comprises one of a plurality of content for distribution, and wherein the download manager is further to determine to download selected ones of the plurality of content that correspond to at least one of a plurality of applications on a device.

24. The apparatus of claim 18, wherein the download manager is further for determining to download the content by determining according to a download rule that compares a content characteristic to a device user preference and identifies a match.

25. The apparatus of claim 18, wherein the download manager is further to:
receive a content index that identifies the content;
receive a user selection of the content from the content index; and
retrieve the content from a memory on a device if the content is stored in the memory,
wherein the downloading further comprises downloading if the content is not stored in the memory.

26. The apparatus of claim 18, wherein the prioritization code corresponds to a fee.

27. The apparatus of claim 18, wherein the downloading comprises receiving via a one-to-many transmission.

28. A method for acquiring content, the method comprising:
receiving a first portion of a content item via a one-to-many transmission at a device from a first link;
detecting a triggering event for the content item; and
accessing a second portion of the content item via a second transmission.

29. At least one processor for acquiring content, the at least one processor comprising:
a first module for receiving a first portion of a content item via a one-to-many transmission at a device from a first link;
a second module for detecting a triggering event for the content item; and
a third module for accessing a second portion of the content item via a second transmission.

30. A computer program product for acquiring content, the computer program product comprising:
a non-transitory computer-readable storage medium comprising:
at least one instruction for causing a computer to receive a first portion of a content item via a one-to-many transmission at a device from a first link;
at least one instruction for causing the computer to detect a triggering event for the content item; and
at least one instruction for causing the computer to access a second portion of the content item via a second transmission.

31. An apparatus for acquiring content, the apparatus comprising:
means for receiving a first portion of a content item via a one-to-many transmission at a device from a first link;
means for detecting a triggering event for the content item; and
means for accessing a second portion of the content item via a second transmission.

32. An apparatus for acquiring content, the apparatus comprising:
a receiver for receiving a first portion of a content item via a one-to-many transmission at a device from a first link; and
a computing platform for detecting a triggering event for the content item; and
the receiver further for accessing a second portion of the content item via a second transmission.

33. The apparatus of claim 32, wherein the receiver is further for receiving the first portion of the content item by failing to receive the second portion of the content item via the one-to-many transmission of the content item; and
wherein the receiver is further for accessing the second portion of the content item by receiving a one-to-one second transmission.

34. The apparatus of claim 32, further comprising a decoder for chain reaction decoding of the content item.

35. The apparatus of claim 34, wherein the receiver is further for chain reaction decoding by using Raptor code.

36. The apparatus of claim 34, wherein the decoder is further for chain reaction decoding of a one-to-many re-transmission of at least a selected portion of the content item that was chain reaction encoded.

37. The apparatus of claim 32, wherein the receiver is further for receiving the first portion of the content item via the one-to-many transmission at the device from a first link by deferring storage of the second portion due to prioritization of the content item; and
wherein the computing platform is further for detecting the triggering event for the content item by detecting a selected one of a user input associated with the content item, a change in a device parameter associated with capacity to receive the content item, availability of a subscription for the content item, and availability of a type of link for receiving the second portion of the content item.

38. The apparatus of claim 37, further comprising a user interface for indicating a status for accessibility of the content item.

39. The apparatus of claim 38, wherein the user interface is further for indicating the status for accessibility of the content item by displaying an annotation or icon for the content indicating a selected one of stored for use, pending access upon acquiring a selected type of link, or access pending user selection.

40. The apparatus of claim 38, wherein presenting the user interface indicating the status for accessibility of the content item by displaying indications for the first portion received and the second portion not received of the content item.

41. The apparatus of claim 38, wherein the receiver is further for accessing the second portion of the content item by accessing an unlocking component for the content item.

42. The apparatus of claim 41, wherein accessing the unlocking component for the content item further comprises accessing a purchasing system via the second transmission from a cellular network.

43. A method for distributing content, the method comprising:
chain reaction encoding a content item;
transmitting the content item as encoded via a one-to-many transmission from a first link to a population of mobile devices; and
retransmitting at least a portion of the content item as encoded via a second transmission.

44. At least one processor for distributing content, the at least one processor comprising:
a first module for chain reaction encoding a content item;
a second module for transmitting the content item as encoded via a one-to-many transmission from a first link to a population of mobile devices; and
a third module for retransmitting at least a portion of the content item as encoded via a second transmission.

45. A computer program product for distributing content, the computer program product comprising:
a non-transitory computer-readable storage medium comprising:
at least one instruction for causing a computer to chain reaction encode a content item;
at least one instruction for causing the computer to transmit the content item as encoded via a one-to-many transmission from a first link to a population of mobile devices; and
at least one instruction for causing the computer to retransmit at least a portion of the content item as encoded via a second transmission.

46. An apparatus for distributing content, the apparatus comprising:
means for chain reaction encoding a content item;
means for transmitting the content item as encoded via a one-to-many transmission from a first link to a population of mobile devices; and
means for retransmitting at least a portion of the content item as encoded via a second transmission.

47. An apparatus for distributing content, the apparatus comprising:
an encoder for chain reaction encoding a content item;
a transmitter for transmitting the content item as encoded via a one-to-many transmission from a first link to a population of mobile devices; and
a network interface for retransmitting at least a portion of the content item as encoded via a second transmission.

48. The apparatus of claim 47, wherein the network interface is further for retransmitting the at least the portion of the content item by a one-to-one second transmission.

49. The apparatus of claim 47, wherein the network interface is further for retransmitting the at least the portion of the content item by determining that a subset of the population of mobile devices failed to receive the content item.

50. The apparatus of claim 47, wherein the encoder is further for chain reaction encoding by using Raptor code.

51. The apparatus of claim 47, wherein the network interface is further for retransmitting the at least the portion of the content item by a one-to-many second transmission.

52. The apparatus of claim 47, wherein the encoder is further for chain reaction encoding the content item by encoding an intended destination directory for cache storage on each of the population of mobile devices.

53. The apparatus of claim 47, wherein the network interface is further for retransmitting the at least the portion of the content item by transmitting an unlocking component for the content item.

54. The apparatus of claim 53, wherein the network interface is further for transmitting the unlocking component for the content item by accessing the unlocking component from a purchasing system and transmitting the second transmission from a cellular network.

55. A method for acquiring content in a mobile environment, comprising:
receiving a content item by an autonomous network interface at a device;
caching the content item by the autonomous network interface in a computer-readable storage medium; and
accessing of the content item by a content consuming component at the device.

56. At least one processor for acquiring content in a mobile environment, comprising:
a first module for receiving a content item by an autonomous network interface at a device;
a second module for caching the content item by the autonomous network interface in a computer-readable storage medium; and
a third module for accessing of the content item by a content consuming component at the device.

57. A computer program product for acquiring content in a mobile environment, comprising:
a non-transitory computer-readable storage medium for storing instructions comprising:
at least one instruction for causing a computer to receive a content item by an autonomous network interface at a device;
at least one instruction for causing the computer to cache the content item by the autonomous network interface in a computer-readable storage medium; and
at least one instruction for causing the computer to access of the content item by a content consuming component at the device.

58. An apparatus for acquiring content in a mobile environment, comprising:
means for receiving a content item by an autonomous network interface at a device;
means for caching the content item by the autonomous network interface in a computer-readable storage medium; and
means for accessing of the content item by a content consuming component at the device.

59. An apparatus for acquiring content in a mobile environment, comprising:
a computer-readable storage medium;
an autonomous network interface for receiving a content item at a device and for caching the content item in the computer-readable storage medium; and
a content consuming component at the device for accessing the content item.

60. The apparatus of claim 59, further comprising a computing platform that executes the content consuming component for suspending operation of a computing platform while receiving the content item by the autonomous network interface.

61. The apparatus of claim 59, wherein receiving the content item by the autonomous network interface at the device further comprises receiving the content item via a one-to-many transmission.
